(19) United States
(12) Patent Application Publication
(10) Pub. No.: US 2026/0031286 A1
(43) Pub. Date: Jan. 29, 2026

(54) CONTROL CIRCUIT OF A HYBRID SWITCH

(71) Applicant: Ellenberger & Poensgen GmbH, Altdorf (DE)

(72) Inventors: Hendrik-Christian KOEPF, Nuernberg (DE); Alexander LABS, Winkelhaid (DE); Peter STEEGMUELLER, Nuernberg (DE); Christian STROBL, Nuernberg (DE)

(73) Assignee: Ellenberger & Poensgen GmbH, Altdorf (DE)

(21) Appl. No.: 19/350,824

(22) Filed: Oct. 6, 2025

Related U.S. Application Data
(63) Continuation of application No. PCT/EP2024/053563, filed on Feb. 13, 2024.

(30) Foreign Application Priority Data
Apr. 6, 2023 (DE) 10 2023 203 236.8

(51) Int. Cl. H01H 9/54

(52) U.S. Cl. CPC H01H 9/548; H01H 2009/544; H01H 2009/546

(57) ABSTRACT

A control circuit of a hybrid switch comprising a main current path, which has a disconnecting element, and an auxiliary current path, which is connected in parallel with the main current path and has a semiconductor switch. The control circuit has a first terminal for the disconnecting element and a second terminal for the semiconductor switch and is configured to carry out a method in which a request for interrupting a current flow via the hybrid switch is recognized. A temporal sequence of an electrical voltage applied to each of the two terminals is chosen depending on the disconnecting element connected to the first terminal and the semiconductor switch connected to the second terminal. Furthermore, a hybrid switch is also provided.

This nonprovisional application is a continuation of International Application No. PCT/EP2024/053563, which was filed on Feb. 13, 2024, and which claims priority to German Patent Application No. 10 2023 203 236.8, which was filed in Germany on Apr. 6, 2023, and which are both herein incorporated by reference.

### BACKGROUND OF THE INVENTION

### Field of the Invention

The invention relates to a control circuit of a hybrid switch and a hybrid switch. The hybrid switch comprises a main current path, which has a disconnecting element, and an auxiliary current path, which is connected in parallel with the main current path and has a semiconductor switch.

### Description of the Background Art

From WO 2010/108 565 A1, which corresponds to US 2012/0007657, which is incorporated herein by reference, a hybrid switch (hybrid disconnector) is known, comprising a mechanical switch or disconnecting element and semiconductor electronics connected in parallel thereto, which comprise a semiconductor switch, preferably an IGBT. The semiconductor electronics have no additional energy source and are current-blocking, i.e., practically without current and voltage, when the mechanical switch is closed. For current interruption via the hybrid switch, the mechanical switch is opened, which can cause an arc. The energy of the arc generated when the mechanical switch is opened is used by the semiconductor electronics, wherein the semiconductor electronics are connected to the mechanical switch in such a way that when the mechanical switch opens, the arc voltage above it (as a result of the arc) causes the semiconductor switch to conduct current.

Once the semiconductor switch is conductive, the electric current from the mechanical switch begins to commutate to the semiconductor switch. The corresponding arc voltage or arc current also charges an energy storage device in the form of a capacitor, which is used to provide control voltage for the semiconductor electronics. As soon as the electric current has commutated to the semiconductor switch, the arc is extinguished, and the charging process of the energy storage device is completed. There is an ionized gas between the switching contacts of the mechanical switch, which is created by the arc and is degraded over time. Following the charging process, a time element starts, during which the semiconductor switch continues to be current-carrying via the energy storage. After the time period of the time element has elapsed, the semiconductor switch is again current-locked. Instead of using the time element, for example, the duration is specified on the basis of the state of charge of the energy storage device.

If the length of time is too short, it is possible that due to the ionized gas still present between the switching contacts of the mechanical switch and the applied electric voltage, another arc ignites, so that an electric current flows again over the mechanical switches. Therefore, the duration is usually chosen to be comparatively long, assuming that after this the ionized gas has been sufficiently degraded and/or the distance between the switching contacts of the mechanical switch is large enough, so that re-ignition of the arc does not occur.

Such a hybrid switch is also known from EP 1 881 511 A1. In this case, however, the semiconductor switch is closed essentially at the same time as the mechanical switch begins to open, so that when the contacts of the mechanical switch mechanically release, a current flow is already taking place via the semiconductor switch. This avoids the formation of an arc. However, an external voltage source is required to actuate the semiconductor switch.

Since a comparatively large electric current is carried by the semiconductor switch in the example according to EP 1 881 511 A1, it is necessary to design it comparatively robustly. In other words, it is not possible to operate the hybrid switch shown in WO 2010/108565 A1, in which only a comparatively small electric current is carried by the semiconductor switch, in accordance with the method known from EP 1 881 511 A1, even if an external voltage source is available. Therefore, the wiring of the individual components is adapted to the respective hybrid switch, and it is not possible to use identical parts in production. Therefore, the manufacturing costs of each hybrid switch are comparatively high.

### SUMMARY OF THE INVENTION

It is therefore an object of the present invention to provide a particularly suitable control circuit of a hybrid switch and a particularly suitable hybrid switch, with manufacturing costs being expediently reduced.

The control circuit can be part of a hybrid switch when assembled. In other words, the control circuit is provided and configured to form a component of the hybrid switch. Consequently, the control circuit is designed and configured to be mounted on other components of the hybrid switch. In the assembled state, the hybrid switch or other components of the hybrid switch are controlled, in particular via the control circuit, and the control circuit is provided and configured to operate the hybrid switch or at least other components of the hybrid switch.

The hybrid switch can be a disconnecting device, i.e., a switch unit/switching unit. The hybrid switch has a main current path, which is formed in particular between two terminals of the hybrid switch or at least connected between them. The two terminals are used in particular to contact other components of an electric circuit, such as cables or busbars, and are formed, for example, via terminals or plugs. The main current path has a disconnecting element that can be actuated. Here, it is possible to move it to a closed state, in which, in particular, the main current path is low-impedance, so that in particular a current flow between the two ends of the main current path, expediently between the two terminals, is possible. In an open state, on the other hand, the disconnecting element is designed with high impedance, so that a current flow through the main current path is essentially not possible, or at least so that there is an increased ohmic resistance. In summary, the disconnecting element is in particular electrically conductive in the closed state and electrically non-conductive in the open state.

Suitably, the disconnecting element can be a galvanically isolating component, as long as it is open. Appropriately, the disconnecting element is a mechanical switch, such as a relay, a contactor or a plug, or at least includes one of them. Alternatively, the disconnecting element can be designed in the manner of a surge protector. In particular, the overvoltage protector has or at least includes a spark gap, which is also known as a gas discharge tube (GDT). The disconnecting element is particularly suitable, preferably provided for and configured, to galvanically separate the main current path when it is opened, i.e., when it is moved to the open state.

The hybrid switch also has an auxiliary current path which includes a semiconductor switch. In particular, the semiconductor switch is connected in parallel to the disconnecting element, so that the disconnecting element is bypassed by the semiconductor switch. Alternatively, for example, other components of the main current path are bypassed by the semiconductor switch. Suitably, the semiconductor switch is a power semiconductor switch and preferably a field-effect transistor, such as a MOSFET, or an IGBT or GTO. In particular, in normal operation, i.e., when a current flow is to occur via the hybrid switch, the semiconductor switch is current-blocking. Thus, electric losses of the hybrid switch during operation are comparatively low. When the semiconductor switch is open, it has a high-impedance design, so that a current flow over it is essentially not possible. In other words, when open, the semiconductor switch is electrically non-conductive. When closed, the semiconductor switch is low-impedance and therefore electrically conductive.

The control circuit is suitable, in particular provided and configured, to be electrically contacted with the disconnecting element and the semiconductor switch. In particular, the disconnecting element and the semiconductor switch are suitable, provided and configured to be controlled during operation by the control circuit and can thus in particular be electrically operated.

The control circuit can have a first terminal for the disconnecting element and a second terminal for the semiconductor switch. In the assembled state, the disconnecting element is connected to the first terminal and the semiconductor switch to the second terminal. To actuate the semiconductor switch/disconnecting element, a corresponding electric voltage is applied to the respective terminal, so that the state of the semiconductor switch or the disconnecting element is changed and this is in particular electrically conductive or electrically non-conductive. The control circuit is suitable, in particular provided and configured, to apply a different electric voltage to the respective terminals, and, in particular, the application of the respective electric voltage to the terminals is possible independently of each other. To open and close the disconnecting element/semiconductor switch, the corresponding electric voltage is applied to the respective terminal. The applied electric voltage is always different from 0 V, for example. Preferably, at least one of the applied electric voltages is equal to 0 V. In particular, the respective applied electric voltage is adapted to the respective semiconductor/disconnecting element used.

The control circuit can be provided and configured to carry out a method. In other words, when operated, the control circuit performs the method. According to the method, a request for interrupting a current flow via the hybrid switch is recognized. For example, the request is made available externally and received via the control circuit. In particular, the control circuit has a corresponding interface for this purpose. Alternatively or in combination thereto, the request is created via the control circuit or at least the hybrid switch itself, for example when manually operating an input device, such as a switch, or due to a malfunction, for example in the event of a fault current, an overcurrent and/or an overvoltage. In this case, for example, the hybrid switch is a component of a circuit breaker or embodies a circuit breaker.

The method thus serves in particular to interrupt the current flow via the hybrid switch, for the purpose of DC interruption. In other words, the method involves interrupting an electric current between a DC power source and an electric device that are electrically connected via the hybrid switch. In particular, the method is therefore only initiated when an electric circuit is carried via the hybrid switch. The hybrid switch can be unidirectional or bidirectional. For example, the electric voltages that can be switched via the hybrid switch, preferably the respective nominal voltage, are between 200 V and 3 kV and in particular 220 V, 400 V, 650 V, 1000V or 1500 V.

In particular, the control circuit can have one or more sensor terminals via which current data about the electric current carried by the hybrid switch and/or the electric voltage applied to it can be received. In particular, in the assembled state, a corresponding sensor of the hybrid switch is connected to each sensor terminal(s), such as a current sensor and/or an electric voltage sensor. In particular, the measurement data is used to check whether the malfunction is present and, if so, the request is created.

According to the method, a temporal sequence of an electric voltage applied to each of the two terminals can be selected depending on the disconnecting element connected to the first terminal and the semiconductor switch connected to the second terminal. In other words, in the case of different connected disconnecting elements and/or semiconductor switches, i.e., in particular different kinds or types of disconnecting elements/semiconductor switches, which in particular have different electric performance data and/or properties, the chronological sequence changes. For example, after recognizing the request to interrupt, the system first checks what type of disconnecting element is connected to the first terminal and what type of semiconductor switch is connected to the second terminal. Alternatively, this is stored, for example, in the control circuit, for example in a memory, and is read out accordingly. Alternatively, one or more switches, such as coding switches, or jumper plugs, are set depending on the disconnecting element/semiconductor switch used, and the setting is read out.

It is possible, for example, that an electric voltage can be first applied to the second terminal, so that the semiconductor switch is closed. Next, for example, the disconnecting element is opened, whereupon a corresponding electric voltage is applied to the first terminal. Subsequently, the semiconductor switch is opened again, whereupon the electric voltage applied to the second terminal is adjusted. Thus, the electric current guided by the hybrid switch first commutates onto the auxiliary current path, so that no arc occurs when the disconnecting element is opened. By subsequently opening the semiconductor switch, the current flow is then safely interrupted. With this variant, there is no arc, which is why in such a switching operation of the hybrid switch there is essentially no load on the disconnecting element.

Alternatively, for example, the semiconductor switch can be closed essentially at the same time as the disconnecting element is opened, so that the commutation of the electric current also essentially immediately takes place when the disconnecting element is opened. For opening and closing the disconnecting element/semiconductor switch, the corresponding electric voltage is applied to the respective terminal. In this variant, it is possible that an arc may occur for a short time, but it will extinguish essentially immediately due to the commutation of the electric current on the auxiliary current path. Subsequently, the semiconductor switch in particular is opened, so that the electric current flow is interrupted. This method reduces the time it takes for the hybrid switch to reach its electrically non-conductive state. However, the load on the disconnecting element is increased.

For example, in the case of another semiconductor switch and/or disconnecting element used, the disconnecting element is first opened, with the semiconductor switch also being open, which is why an arc can form due to the electric voltage now applied, so that an electric current continues to flow over the disconnecting element. Only afterwards is the semiconductor switch closed, so that the electric current commutes to the auxiliary current path and the arc extinguishes. The semiconductor switch is then opened, so that the flow of electric current is safely prevented. In this case, the load on the semiconductor switch is reduced.

In particular, not only the temporal sequence of applying the respective electric voltage, i.e., the opening and closing of the latter via the disconnecting element/semiconductor switch used is specified, but also, for example, the time interval in which the respective opening/closing of the semiconductor switch/disconnecting element takes place, for which the corresponding electric voltage is applied. For example, the timing for switching on the semiconductor switch is determined depending on the presence of an extinguishing chamber in the disconnecting element. If this is present, it is useful to close the semiconductor switch when the arc reaches the extinguishing chamber. The period of time during which the semiconductor switch remains in the open state after the disconnecting element has been opened is reduced compared to the use of a disconnecting element that does not have an extinguishing chamber. Due to the extinguishing chamber, the electric voltage required to maintain the arc is increased. This way, re-ignition of the arc is avoided when the semiconductor switch is subsequently opened, after the electric current has commutated to the auxiliary current path.

In a further development, the respective (electric) voltage can be adjusted alternatively or in combination in such a way that the electric current flow is limited. In other words, for example, the voltage applied to the second terminal does not lead to a complete closure of the semiconductor switch, and this, for example, it is not fully controlled. Therefore, the semiconductor switch continues to exhibit electric resistance.

Since the time sequence for applying the respective electric voltage depends on the respective semiconductor switch/disconnecting element used, it is possible to use the control circuit with a wide variety of hybrid switches and to combine it with a wide variety of semiconductor switches/disconnecting elements. These can be adapted to the respective application, which increases flexibility. In this case, the temporal sequence of the actuation of the semiconductor switch and the disconnecting element are also adjusted accordingly after the request to interrupt the current flow has been received. Here, no change or adjustment of the control circuit is required. As a consequence, the control circuit can be produced in comparatively large quantities, reducing manufacturing costs. The method relate in particular to the method for operating the control circuit or the hybrid switch to which the above-mentioned work steps are carried out.

Expediently, the method is carried out based on the wiring of the individual components of the control circuit, for example of discrete components, such as electric components, e.g., resistors, capacitors, diodes or inductors. Preferably, the control circuit comprises an application-specific integrated circuit (ASIC) and is formed via it, for example. Alternatively or in combination with this, the control circuit has a computer that is suitably programmable. For example, the computer is a programmable microprocessor or encompasses one. Expediently, the control circuit has a storage medium on which a computer program product, also known as a computer program, is stored, wherein, when this computer program product is executed, i.e., the program, the computer is instructed to carry out the method. In summary, the control circuit is purposefully constructed in such a way, and the individual components/parts of the control circuit are preferably wired in such a way, that the method is carried out during operation. For example, the connection is provided via a common printed circuit board, or the control circuit has several corresponding printed circuit boards.

Purposefully, the method, and thus also the control circuit, can be designed in such a way that, if the current-carrying capacity of the semiconductor switch is less than a threshold value, an electric voltage is first applied to the first terminal which causes the disconnecting element to open. For example, the current-carrying capacity of the semiconductor switch is stored in the control circuit or intrinsically determined due to the semiconductor switch used, or at least its type. The threshold value is adapted, for example, to the respective purpose of the hybrid switch, for example a rated current that is carried by the hybrid switch. Alternatively, the threshold value is given in absolute terms. After a time window following the opening of the disconnecting element, during which time in particular the arc is formed in the disconnecting element, an electric voltage is applied to the second terminal for a period of time, causing the semiconductor switch to close. After the period of time has elapsed, the application of this electric voltage is terminated, and the semiconductor switch is preferably put back into the open state. The period of time is comparatively short and overall in particular shorter than 1 us. Expediently, the period of time is greater than 1 ms or at least 1 ns. The time window, on the other hand, is greater than the period of time and in particular greater than 10 ms and preferably less than 10 us.

Due to this configuration, the arc can be initially formed during current interruption. When the time window has passed, the arc has a comparatively large length or the arc voltage, i.e., the electric voltage required to maintain the arc, is comparatively large. If the semiconductor switch is now at least closed briefly, namely for the period of time, the electric current commutates from the main current path to the auxiliary current path. After the period of time has elapsed, the semiconductor switch is opened again, thus interrupting the flow of electric current through the auxiliary current path. The electric voltage that is now applied is not sufficient to re-ignite the arc, so that after a comparatively short period of time, the hybrid switch is electrically non-conductive. The semiconductor switch only carries the electric current for the period of time, which reduces the load on the semiconductor switch. For this reason, and due to the reduced current-carrying capacity, it is possible to use a comparatively inexpensive semiconductor switch.

For example, the control circuit can have a third terminal for connection to an external voltage source. The third terminal is suitable for this purpose, in particular provided and configured. At least some of the other components/parts of the control circuit are suitably connected to the third terminal in such a way that, during operation, the external voltage source is supplied with electric energy provided that the external voltage source is connected to the third terminal. The method, and thus also the control circuit, are expediently designed in such a way that if an electric supply voltage is applied to the third terminal, first an electric voltage causing the closing of the semiconductor switch is applied to the second terminal. Subsequently, or at most at the same time, an electric voltage is applied to the first terminal that causes the disconnecting element to be opened. Thus, the electric current commutates from the main current path to the auxiliary current path when or before the disconnecting element is opened, which is why no arc is formed when the disconnecting element is opened. This reduces the load on the disconnecting element, and the latter can be chosen to be comparatively cost-efficient, especially without the need for an extinguishing chamber. This temporal sequence of the control of the semiconductor switch and the disconnecting element is expediently only or at least also carried out if the disconnecting element has no extinguishing chamber. Since a supply is made via the third terminal of the control circuit during operation, it is possible to arbitrarily choose the time interval between the closing of the semiconductor switch and the opening of the disconnecting element, or this is done in particular depending on the semiconductor switch/disconnecting element used/connected. For example, in a semiconductor switch that has a comparatively high current-carrying capacity, the time interval is in particular chosen to be greater.

Particularly preferred, the method, and thus also the control circuit, can be designed in such a way that, if no electric supply voltage is applied to the third terminal, an electric voltage which causes the disconnecting element to open is first applied to the first terminal. Subsequently, i.e., at a time interval thereafter, an electric voltage is applied to the second terminal which causes the semiconductor switch to close. In particular, an electric voltage arising from the arc forming above the disconnecting element is used to apply the electric voltage, which causes the semiconductor switch to close, at the second terminal. For example, an energy storage device is charged on the basis of the electric voltage generated by the disconnecting element, and the corresponding electric voltage is subsequently applied to the second terminal via the energy storage device. In particular, a constant period of time is formed between the opening of the disconnecting element and the closing of the semiconductor switch.

Due to this method, it is possible to supply the hybrid switch with the external voltage source, so that switching is possible without forming an arc. However, it is also possible to use the hybrid switch in a mounting situation in which no external voltage source is available. Also, if, for example, there is a malfunction, and in particular an electric cable connected to the third terminal tears off, via which the hybrid switch and the external voltage source are connected, the electric current flow is nevertheless safely interrupted via the hybrid switch.

Preferably, the control circuit can have a fourth terminal for connecting to a second semiconductor switch. The fourth terminal is suitable for this purpose, in particular provided and configured. In the assembled state, the second semiconductor switch is electrically connected in series with the disconnecting element and thus a component of the main current path. Appropriately, the method, and consequently also the control circuit, is designed in such a way that an electric voltage that causes the second semiconductor switch to be opened is applied to the fourth terminal, if it is recognized that the second semiconductor switch is connected to the fourth terminal. Subsequently, an electric voltage that causes the disconnecting element to open is applied to the first terminal. Preferably, prior to applying the electric voltage causing the second semiconductor switch to open, an electric voltage causing the semiconductor switch to close is applied to the second terminal. This way, via the second semiconductor switch, a current flow through the main current path is interrupted, so that the electric current completely commutates to the auxiliary current path. The electric voltage across the second semiconductor switch, i.e., the main current path, is comparatively low due to the closed semiconductor switch, so that only comparatively low losses occur in the second semiconductor switch and the load on the second semiconductor switch is comparatively low. Subsequently, an electric voltage is applied to the second terminal in particular in such a way that the semiconductor switch is opened, thus interrupting the flow of current via the hybrid switch. In particular, the disconnecting element can be opened arbitrarily or at least independently of the opening of the semiconductor switch. If, on the other hand, it has been recognized that there is no second semiconductor switch connected to the fourth terminal, no electric voltage is applied to it in particular, or, for example, in this case the semiconductor switch is not closed until the disconnecting element has been opened.

To detect whether the second semiconductor switch is connected to the fourth terminal, for example, a query can be performed on a resistor provided at the fourth terminal. Alternatively, a configuration is read out, which was stored by software, for example, preferably in a memory. Alternatively, the configuration is stored via mechanical adjustment, for example via the corresponding configuration of a jumper plug or the like. In another alternative, the corresponding electric voltage that causes the opening is initially applied for recognition, and if, for example, an electric current flow occurs, the application is maintained, as this only occurs when the second semiconductor switch is connected. Alternatively, the application of the corresponding electric voltage is maintained, regardless of whether an electric current is flowing. This means that it is not necessary to provide an appropriate sensor, which reduces manufacturing costs of the control circuit.

The method, and thus the control circuit, is particularly preferably configured in such a way that the temporal sequence is also adjusted according to a current state, in particular the current state of the control circuit and/or the disconnecting element/semiconductor switch used. In particular, the current state is first determined, for example on the basis of a theoretical model. Alternatively, for example, measurement data provided by one or more of the sensor terminals can be used to determine the state. For example, if the temperature of the semiconductor switch rises, further stress is avoided, and it is always left in the closed state. In this case, only the disconnecting element is opened, which is why the duration during which the electric current still flows is comparatively long.

The hybrid switch can have a main current path with a disconnecting element and an auxiliary current path, connected in parallel with the main current path, with a semiconductor switch. The disconnecting element is, for example, a mechanical switch, such as a relay or contactor. Alternatively, the disconnecting element is designed in the manner of a plug, for example. In particular, the disconnecting element is designed in such a way that when it is opened, i.e., when the ohmic resistance is increased, there is a mechanical separation of two contacts through which an electric current flows in the closed state, wherein the two contacts are mechanically connected to each other. The semiconductor switch is suitable a power semiconductor switch and, for example, an IGBT or MOSFET.

The hybrid switch also can include a control circuit with a first terminal to which the disconnecting element is connected. In addition, the control circuit has a second terminal to which the semiconductor switch is connected. For example, the semiconductor switch/disconnecting element is releasably connected to the respective connector, which is in particular designed as a plug. Alternatively, the semiconductor switch and/or the disconnecting element is soldered to the respective terminal or electrically contacted in some other way. The two terminals are designed in the same way as the disconnecting element/semiconductor switch, and these can be used in particular to apply a respective electric voltage to the disconnecting element and the semiconductor switch, so that they are controlled via the control circuit. This makes it possible to use the control circuit to change a (switching) state of the semiconductor switch/disconnecting element, in particular to switch it from an open to a closed state, and vice versa.

The control circuit can be provided and configured to carry out a method in which a request to interrupt a current flow via the hybrid switch is recognized. In other words, the request specifies that an electric current that is carried via the hybrid switch is to be interrupted. A temporal sequence of an electric voltage applied to each of the two terminals is chosen depending on the disconnecting element connected to the first terminal and the semiconductor switch connected to the second terminal.

In particular, the hybrid switch can be used in a DC circuit, and the method is carried out in particular for direct current interruption. For example, when assembled, the hybrid switch can be a component of industrial automation, street lighting, a ship's electric system, electrified aviation, railway infrastructure or rail propulsion systems for an island network in the private domestic sector, an energy generator, a greenhouse or it can be used in the field of electric mobility, for example in a motor vehicle, in agriculture or in a construction site vehicle. The hybrid switch is particularly suitable for this purpose and is appropriately designed and configured.

The further developments and advantages explained in connection with the control circuit are also applicable to the method/the hybrid switch/the use and to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a hybrid switch with a control circuit, and

FIG. 2 shows a method carried out by the control circuit.

### DETAILED DESCRIPTION

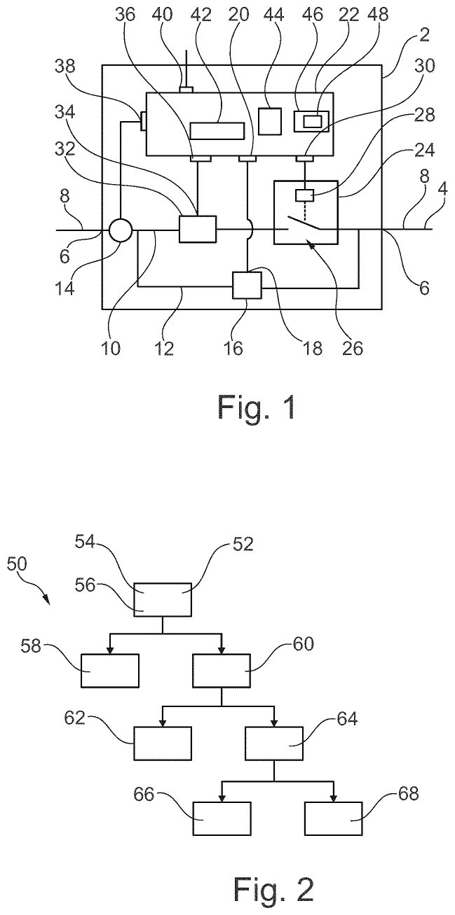

FIG. 1 schematically simplifies a hybrid switch 2 that is used in a DC circuit 4. The hybrid switch 2 has two terminals 6, each connected to a line 8 of the DC circuit 4. The direct current circuit 4 is a component of a railway infrastructure, and via this, i.e., through the lines 8, an electric current of more than 50 A is carried during normal operation, wherein an electric voltage relative to a mass not shown is greater than 300 V.

The hybrid switch 2 has a main current path 10 which is connected between the two terminals 6 and which is bypassed with an auxiliary current path 12. Between one of the terminals 6 and the main current path 10, and consequently also between this terminal 6 and the auxiliary current path 12, a sensor 14 is connected or at least assigned to the part of a power line located there, via which the main current path 10 and the auxiliary current path 12 are electrically connected to this terminal 6. The sensor 14 is a current sensor which can be used to measure the electric current flowing between the terminals 6. In summary, the two terminals 6 are electrically connected via the main current path 10 and via the auxiliary current path 12.

The auxiliary current path 12 has a semiconductor switch 16. This is designed as an IGBT or MOSFET and is introduced into the auxiliary current path 12 in such a way that an electric current flow can be created or interrupted through the auxiliary current path 12. For this purpose, it is possible to move the semiconductor switch 16 into the closed state, so that the electric resistance provided by the semiconductor switch 16 is essentially negligible. It is also possible to open the semiconductor switch 16, i.e., to switch it to the current-blocking position so that it is electrically non-conductive. In this case, the electric resistance provided by the semiconductor switch 16 is comparatively high. It is also possible to move the semiconductor switch 16 into a state in which it is not fully controlled. In this case, an electric resistance is provided via the semiconductor switch 16, which is between 5 ohms and 200 ohms, so that the electric current carried by the semiconductor switch 16 is limited.

The state of the semiconductor switch 16 is set by applying an electric voltage to a control input 18 of the semiconductor switch 16, which is connected to a second terminal 20 of a control circuit 22. This makes it possible to control the semiconductor switch 16 via the control circuit 22, and the switching state, i.e., whether the semiconductor switch 16 is electrically conductive or electrically non-conductive, is set by applying a corresponding electric voltage to the second terminal 20. Consequently, the control circuit 22 is used to set whether an electric current flow between the two terminals 6 through the auxiliary current path 12 is possible.

The main current path 10 has a disconnecting element 24 in the form of a mechanical switch, namely a relay or the like. The disconnecting element 24 can also be moved to a closed or an open state, wherein in the closed state, a flow of electric current through the disconnecting element 24 is possible. For this purpose, the disconnecting element 24 has a mechanical part 26 which is electrically contacted with the other components of the main current path 10. The mechanical part 26, for example, includes a moving contact that can be moved relative to a fixed contact. If the two contacts are adjacent to each other, an electric current flow through the main current path 10 is possible. If, on the other hand, the contacts are spaced apart, an electric current flow through the main current path 10 is prevented. In addition, the disconnecting element 24 has an electric part 28 via which a movement of the mechanical part 26 is caused so that it is either in the electrically conductive or in the electrically non-conductive state. For example, the electric part 28 includes a coil to create a magnetic field when needed. The electric part 28 is electrically contacted with a first terminal 30 of the control circuit 22. If a corresponding electric voltage is applied to the first terminal 30, the electric part 28 is operated accordingly, so that the mechanical part 26 is actuated. Consequently, the state of the disconnecting element 24 is changed by applying a corresponding electric voltage to the first terminal 30.

A second semiconductor switch 32, which has another control input 34, is electrically connected in series to the disconnecting element 24. This is electrically contacted with a fourth terminal 36 of the control circuit 22, so that by applying a corresponding electric voltage to the fourth terminal 36, the switching state of the second semiconductor switch 32 is set. The control circuit 22 also includes a sensor terminal 38 to which the sensor 14 is connected, so that the measurement data generated by the sensor 14, in particular an electric voltage corresponding to the electric current carried between the terminals 6, is made available there.

The control circuit 22 also includes a third terminal 40 to which an external voltage source is connected. Via the external voltage source, an electric supply voltage is provided, namely a DC voltage of 12 V, and the supply voltage applied to the third terminal 40 is used for the current supply of the other components of the control circuit 22, i.e., also for a schematically simplified wiring 42 of the control circuit 22. The wiring 42 has several discrete electric components, such as electric coils, capacitors and resistors, which are not shown individually. The control circuit 22 also includes a computer 44 in the form of a programmable microprocessor and a storage medium in the form of a memory 46. A computer program product 48 is stored in the memory 46.

In this case, the wiring 42 is constructed in such a way that at least in part a method 50 shown in FIG. 2 is carried out. The computer program product 48 also comprises several commands which, when the computer 44 executes the program, cause it to perform at least parts of the method 50. In other words, part of the method 50 is carried out via the wiring 42 as well as another part carried out using the computer program product 48 through the computer 44. This way, the control circuit 22 is provided and configured to carry out the method 50, and the hybrid switch 2 is at least partly operated in accordance with the method 50.

In an unspecified variant or installation situation of the hybrid switch 2, the external voltage source is not connected to the third terminal 30 and/or the sensor 14 is not present. It is also possible that the second semiconductor switch 32 is not present. In addition, it is possible to replace the disconnecting element 24, which is shown here as a relay, with a different mechanical switching element. It is also possible to replace the semiconductor switch, namely the MOSFET or IGBT, with another MOSFET or IGBT or, for example, with a GTO. In these variants, however, the control circuit 22 is always constructed in the same way.

The method 50 is carried out when an electric current is carried via the hybrid switch 2. In this case, the disconnecting element 24 is in an electrically conductive state, i.e., closed. The second semiconductor switch 32 is also closed, and the semiconductor switch 16 is open.

In the method 50, a request 54 to interrupt a current flow via the hybrid switch 2 is recognized in a first step 52. The request 54 is received, for example, through a data input, not shown, of the control circuit 22, which is connected to a line. The line is connected to an unspecified control unit of the DC circuit 4. Alternatively, the request 54 is created via a manual switch which is inserted into a housing of the hybrid switch 2 and which is electrically connected to the control circuit 22, for example to the data input which is not shown in detail. In another alternative, the request 54 is made via the control circuit 22 itself, namely on the basis of the measurement data provided by the sensor 14. Here, the request 54 is created when the electric current carried via the hybrid switch 2, i.e., the electric current flowing between the two terminals, exceeds a certain limit value. The hybrid switch 2 thus acts in the manner of a circuit breaker.

In addition, in the first step 52, a current state 56 of the hybrid switch 2 is determined. The number of times the two semiconductor switches 16 and 32 were operated within a previous period of time is also monitored. Each switching operation of the respective semiconductor switch 16, 32 causes heat loss. If the number of switching operations is greater than a certain value, i.e., the respective semiconductor switch 16, 32 was operated more than the specified value within the period of time, it is assumed that the hybrid switch 2 is in an overloaded state 56. In this case, only the disconnecting element 24 is opened, for which a corresponding electric voltage is applied to the first terminal 30. Due to the applied electric voltage, the mechanical part 26 is actuated and the disconnecting element 24 is switched to the electrically non-conductive state.

In an example of the disconnecting element 24, the mechanical part 26 comprises a spring via which a force is exerted between the two contacts, i.e., the fixed contact and the moving contact, which leads to a spacing of the two contacts. In order for the disconnecting element 24 to be electrically conductive, it is necessary that a force be exerted by the electric part 28 via which the force provided by the spring is compensated. In particular, the disconnecting element 24 is designed as a monostable switching device. To open the disconnecting element 24, an electric voltage of 0 V is applied to the first terminal. In an example of the disconnecting element 24, on the other hand, an adapted electric voltage is applied, which also leads to an opening.

After opening the disconnecting element 24, due to the applied electric voltage and the carried electric current, it is possible that an arc may form in the disconnecting element 24 and that it is only extinguished after a comparatively long period of time, so that the current flow via the hybrid switch 2 is interrupted. With this type of actuation of the hybrid switch 2, the electric current flow is still maintained for a comparatively long period of time. However, there is no additional load on the semiconductor switches 16, 32.

If, during the determination of the state 56, it was recognized that there is no overload of the two semiconductor switches 16, 32, normal operation of the hybrid switch 2 is possible. In this case, the system checks whether there is an electric supply voltage at the third terminal 40. For example, there may be no electric supply voltage at the third terminal 40 because the external connector source is not connected, or because lines used to connect the external voltage source are damaged or broken.

If there is no electric supply voltage at the third terminal 40, a second step 58 is performed. Since there is no electric supply voltage, there also is no supply to the computer 44, so that the second step 48 is essentially carried out on the basis of the wiring 42. In the second step 58, the disconnecting element 24 is first opened to create the arc. As a result, an electric voltage is applied to the disconnecting element 24 or the complete main current path 10, which is used to supply the wiring 42. In addition, an energy storage device, such as a capacitor, is charged. In a further development, the electric voltage generated is also used to supply the computer 44, so that the second step 58 is carried out in part via the computer 44.

When the disconnecting element 24 is opened, the corresponding electric voltage is applied to the first terminal 30, for example 0 V, so that no force applied by the spring or the like is compensated for via the electric part 28, in particular. Consequently, the mechanical part 26 is placed in a position in which the two contacts are spaced apart from each other.

After the energy storage unit has been sufficiently charged, an electric voltage is applied to the second terminal 20, which causes the semiconductor switch 16 to close. As a result, the electric current commutates from the main current path 10 to the auxiliary current path 12, so that the arc formed in the disconnecting element 24 collapses and no electric current is carried over the main current path 10. Thus, no further supply of the control circuit 22 takes place due to the arc, but only on the basis of the energy storage device. After a period of time, the application of the electric voltage to the second terminal 20 is terminated and thus the semiconductor switch 16 is again opened. Therefore, the flow of electric current through the auxiliary current path 12 is interrupted. In this case, the electric voltage applied between the terminals 6 is insufficient to re-ignite the arc due to the gas in the disconnecting element 24 having cooled down in the meantime, and the current flow via the hybrid switch 2 is interrupted. The method 50 is then complete.

The period of time that the semiconductor switch 16 is electrically conductive is adapted to the respective disconnecting element 24 used and to the semiconductor switch 16. For example, in the case of different disconnecting elements 24 and different semiconductor switches 16, a different period of time is used, wherein the latter in each case is such that the arc is not re-ignited. In each case, the period of time between the recognition of the request 54 and the time from which the hybrid switch 2 no longer carries an electric current is minimal.

If, on the other hand, an electric supply voltage is applied at the third terminal 40, in a third step 60, the current-carrying capacity of the semiconductor switch 16 is checked and compared with a threshold value. The threshold value corresponds to the value of the currently flowing electric current provided by the sensor 14, and the current-carrying capacity is determined on the basis of the connection diagram of the semiconductor switch 16 at the second terminal 20. Alternatively, the current-carrying capacity has been stored in the memory 46 when the semiconductor switch 16 is connected, i.e., during assembly.

If the current-carrying capacity is less than the threshold value, a fourth step 62 is carried out. In this, an electric current causing the disconnecting element 24 to open is applied to the first terminal 30, so that it is opened, wherein the arc forms in the disconnecting element 24. After a subsequent time window of 1 μs, for a period of time, namely 500 ms, an electric voltage causing the semiconductor switch 16 to close is applied to the second terminal 20. Due to the electrically conductive auxiliary current path 12, the electric current commutates from the main current path 10 to the auxiliary current path 12, which is why the arc formed in the disconnecting element 24 is extinguished. In this case, the time window and the time span are chosen in such a way that after the time span, the electric voltage applied between the terminals 6 is not sufficient to re-ignite the arc. Due to the comparatively short period of time for which the electric current is carried via the semiconductor switch 16, its load is comparatively low, so that despite the comparatively low current carrying capacity, there is no damage to the semiconductor switch 16.

In the fourth step 62, the period of time during which the semiconductor switch 16 is closed is shortened as compared to the period of time during which the semiconductor switch 16 is conductive in the second step 58, whereas in the second step 58, as compared to the fourth step 62, the disconnecting element 28 is electrically conductive for a shorter period of time, and thus the arc exists for a shorter period of time.

If the current-carrying capacity of the semiconductor switch 16 is greater than the threshold value, a fifth step 64 is performed. In this step, it is checked whether the fourth terminal 36 is connected to the second semiconductor switch 32. If it is recognized that the second semiconductor switch 32 is not connected, for example because the connection is broken, or because the second semiconductor switch 32 is not present, a sixth step 66 is performed.

In this step, an electric voltage is applied to the second terminal 20, which leads to a closing of the semiconductor switch 16. Thus, the electric current partially commutates to the auxiliary current path 12. Subsequently, an electric voltage is applied to the first terminal 30, which leads to an opening of the disconnecting element 24. This interrupts the still existing electric current through the main current path 10, wherein the electric current flow between the terminals 6 continues through the auxiliary current path 12. In this case, no arc is formed when the disconnecting element 24 is opened, or it is extinguished essentially immediately. The semiconductor switch 16 is reopened after a preselected period of time, for which purpose a corresponding electric voltage is applied to the second terminal 20. The period of time between the closing of the semiconductor switch 16 and the opening of the disconnecting element 24 and the period of time that the semiconductor switch 16 remains in the closed state are adapted to the respective semiconductor switch 16 and the disconnecting element 24 used. For this purpose, for example, the disconnecting element 24 used and the semiconductor switch 16 used are stored in the memory 46 during assembly, or the configuration can be retrieved on the basis of a connector configuration and/or a connection diagram at the respective terminal 20, 30. The time span and the period of time are always chosen in such a way that after opening the semiconductor switch 16, no more electric current is carried by the hybrid switch 2. The period of time between the execution of the first step 52 and the time from which no electric current is carried by the hybrid switch 2 is minimal.

If it has been recognized that the second semiconductor switch 32 is connected to the fourth terminal 36, a seventh step 68 is carried out. In this step, an electric voltage is also applied to the second terminal 20, which causes the semiconductor switch 16 to close. This starts the process of commutating the electric current to the auxiliary current path 12. Essentially immediately after the semiconductor switch 16 has been closed, an electric voltage causing the second semiconductor switch 32 to open is applied to the fourth terminal 36, so that the electric current flow through main current path 10 is interrupted. Hereafter, an electric voltage causing the disconnecting element 24 to open is applied to the first terminal 30. Since there is no longer any electric current flowing through the main current path 10, no arcs are formed. In addition, an electric voltage is applied to the second terminal 20 essentially at the same time, which causes the semiconductor switch 16 to open. In this process, the period of time that elapses between the execution of the first step 52 and the time until no more electric current flows via the hybrid switch 2, is comparatively short. The period of time that elapses between the opening of the semiconductor switch 16 and the closing of the second semiconductor switch 32 is adapted to the respective semiconductor switches 16, 32 used.

In summary, in the method 50, the temporal sequence in which a corresponding electric voltage is applied to each of the terminals 20, 30, 36 is chosen depending on the disconnecting element 24 used in each case, as well as the semiconductor switches 16, 32 and also the applied supply voltage. Here, too, the temporal sequence is adjusted depending on the current state 56.

The invention is not limited to the examples described above. On the contrary, other variants of the invention can also be derived from it by the skilled person without departing from the subject matter of the invention. In particular, all individual features described in connection with the example can also be combined with each other in other ways without departing the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control circuit of a hybrid switch, the control circuit comprising:
a main current path, which has a disconnecting element;
an auxiliary current path, which is connected in parallel with the main current path;
a semiconductor switch;
a first terminal for the disconnecting element;
a second terminal for the semiconductor switch,
wherein a request for interrupting a current flow via the hybrid switch is recognized, and
wherein a temporal sequence of an electric voltage applied to each of the first and second terminals is chosen depending on the disconnecting element connected to the first terminal and the semiconductor switch connected to the second terminal.

2. The control circuit according to claim 1, wherein, if a current-carrying capacity of the semiconductor switch is less than a threshold value, an electric voltage causing the disconnecting element to open is initially applied to the first terminal, and wherein, after a subsequent time window for a period of time, an electric voltage causing the semiconductor switch to close is applied to the second terminal.

3. The control circuit according to claim 1, further comprising a third terminal for connecting to an external voltage source, wherein, if an electric supply voltage is applied to the third terminal, initially an electric voltage causing the semiconductor switch to close is applied to the second terminal and subsequently an electric voltage causing the disconnecting element to open is applied to the first terminal.

4. The control circuit according to claim 3, wherein, if there is no electric supply voltage at the third terminal, initially an electric voltage causing the disconnecting element to open is applied to the first terminal and then an electric voltage causing the semiconductor switch to close is applied to the second terminal.

5. The control circuit according to claim 1, further comprising a fourth terminal or connecting to a second semiconductor switch, which is electrically connected in series with the disconnecting element, wherein if it was recognized that the second semiconductor switch is connected to the fourth terminal, initially an electric voltage causing the second semiconductor switch to open is connected to the fourth terminal and then an electric voltage causing the disconnecting element to open is applied to the first terminal.

6. The control circuit according to claim 1, wherein the control circuit is designed such that the temporal sequence is adjusted depending on a current state.

7. A hybrid switch comprising:
a main current path, which has a disconnecting element;
an auxiliary current path, which is connected in parallel with the main current path;
a semiconductor switch; and
the control circuit according to claim 1,
wherein the disconnecting element is connected to the first terminal and the semiconductor switch is connected to the second terminal.
